(19) United States
(12) Patent Application Publication
(10) Pub. No.: US 2007/0223915 A1
(43) Pub. Date: Sep. 27, 2007

(54) External camera and image photographing apparatus

(75) Inventor: Byeong-woo Yi, Yeonsu-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/515,779

(22) Filed: Sep. 6, 2006

(30) Foreign Application Priority Data
Mar. 27, 2006 (KR) 2006-27480

(51) Int. Cl. G03B 17/02

(52) U.S. Cl. 396/535

(57) ABSTRACT

An image photographing apparatus includes a main body and an external camera connected to the main body via a cable. The external camera includes a case having a receiving space, a cover rotatably connected to the case, and a camera module disposed in the receiving space. The camera module rotates when the cover rotates.

### CROSS-REFERENCE TO RELATED APPLICATIONS

This application claims the benefit under 35 U.S.C. § 119(a) of Korean Patent Applications No. 2006-27480 filed Mar. 27, 2006 in the Korean Intellectual Property Office, the entire disclosure of which is hereby incorporated by reference.

### BACKGROUND OF THE INVENTION

1. Field of the Invention

The present invention relates to a small external camera. More particularly, the present invention relates to an external camera in which the photographing angle can be adjusted and an image photographing apparatus having the same.

2. Description of the Related Art

Generally, a small external camera is an apparatus that is connected to a camcorder and has a simple photography function. The small external camera is mainly used to take pictures using basic functions during leisure, sporting, and other activities.

Referring to FIG. 1, a conventional external camera includes a case 10, a cover 20, and a camera module (not shown).

The case 10 has a substantially cylindrical shape with an open front side. The case 10 has a receiving space for receiving the camera module. The case 10 has a connecting cable 11 for connecting the camera module with a main body (not shown), and a power operating part 12 to operate the camera module.

The cover 20 is fixed to the front side of the case 10. The cover 20 has a lens window 21 provided at the front side of the cover 20, and a LED 22 that blinks on and off according to the operation of the camera module.

The above-described conventional external camera has a structure in that the cover 20 and the case 10, in which the camera module is received, are solidly coupled to each other. Therefore, when the camera module is mounted at the receiving space of the case 10 with an incorrect horizontal photographing angle, the rotation angle of the camera module cannot be adjusted, and images taken by the camera module may be improperly rotated. Consequently, a conventional external camera is disposed inside a separate mount (not shown) to allow the conventional external camera to rotate from side to side. As a result, the horizontal photographing angle of the conventional external camera can be adjusted. However, when the conventional external camera is disposed inside the mount, users are required to open the mount and then rotate the entire conventional external camera. Thus, users cannot easily adjust the photographing angle of the conventional external camera. Furthermore, the conventional external camera must rotate inside the mount, which means that the shape of the conventional external camera must be a simple shape, such as a sphere, or a cylinder.

Accordingly, there is a need for an improved external camera in which the photographing angle can be easily adjusted.

### SUMMARY OF THE INVENTION

An aspect of the present invention is to address at least the above problems and/or disadvantages and to provide at least the advantages described below. Accordingly, an aspect of the present invention is to provide an external camera in which the photographing angle can be adjusted.

Another aspect of the present invention is to provide an image photographing apparatus having the external camera.

The above aspects and/or other features of the present invention can substantially be achieved by providing an external camera comprising a case with a receiving space, a cover rotatably connected to the case, and a camera module disposed in the receiving space. The camera module rotates when the cover rotates.

The camera module may be fixed to the cover.

The camera module may include a lens, an image sensor for sensing images that pass through the lens, a printed circuit board for holding the image sensor, and a connector disposed at the printed circuit board for connecting a cable.

The camera module may further comprise a microphone for picking up sound.

The camera module may further comprise a fixing member for supporting the lens. The fixing member may be fastened to the cover by screws or other fastening members.

The external camera may further comprise a rotation shaft portion for rotatably supporting the camera module.

The rotation shaft portion may comprise a shaft hole formed at the camera module, and a rotation shaft inserted into the shaft hole. The rotation shaft is fixed to the case.

The rotation shaft may have a shaft separation preventing jaw for preventing the rotation shaft inserted into the shaft hole from separating from the shaft hole.

The external camera may further comprise a rotation limiting unit for controlling the rotation angle of the cover with respect to the case.

The rotation limiting unit may comprise a limiting protrusion formed at the cover, and a limiting wall formed at the case. When the cover rotates over a predetermined angular range, the limiting protrusion is caught at the limiting wall so as to prevent the cover from over rotating.

The limiting protrusion may project in an axial direction.

The limiting wall may be formed at an inner circumferential surface of the case and have substantially the same radius as the rotation radius of the limiting protrusion.

The limiting protrusion may have inwardly inclined surfaces at both sides in the rotation direction, and the limiting wall may have outwardly inclined surfaces corresponding to the inwardly inclined surfaces at both ends of the limiting wall.

The case may comprise a socket part coupled to a supporting socket.

The case may further comprise a cable for connecting the camera module to a main body of an image photographing apparatus.

One of the cable or the case may comprise a power operating part for operating the camera module.

The cover may further comprise a LED that blinks on and off according to operation of the camera module.

The cover may further comprise a microphone hole.

The external camera may further comprise a sealing member disposed between the cover and the case.

According to another aspect of the present invention, an image photographing apparatus comprises a main body, and an external camera connected to the main body via a cable. The external camera comprises a case with a receiving space, a cover rotatably connected to the case, and a camera module disposed in the receiving space The camera module rotates when the cover rotates.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a perspective view of a conventional external camera;

FIG. 2 is a perspective view of an external camera according to an exemplary embodiment of the present invention;

FIG. 3 is an exploded perspective view of the external camera of FIG. 2;

FIG. 4 is a perspective view of a rotation supporting structure of a camera module of FIG. 3;

FIG. 5 is a bottom perspective view of the external camera of FIG. 2;

FIGS. 6A and 6B are perspective views of an exemplary embodiment of a rotation limiting structure which is disposed at a cover and a case of the external camera of FIG. 2;

FIGS. 7A and 7B are perspective views of another exemplary embodiment of a rotation limiting structure which is disposed at a cover and a case of the external camera of FIG. 2;

FIGS. 8A and 8B are plan views of the cover and the case of FIGS. 7A and 7B; and

FIG. 9 is a perspective view illustrating the operation of an external camera according to an exemplary embodiment of the present invention.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention and are merely exemplary. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

Hereinafter, certain exemplary embodiments of the present invention will be described in detail with reference to the accompanying drawings.

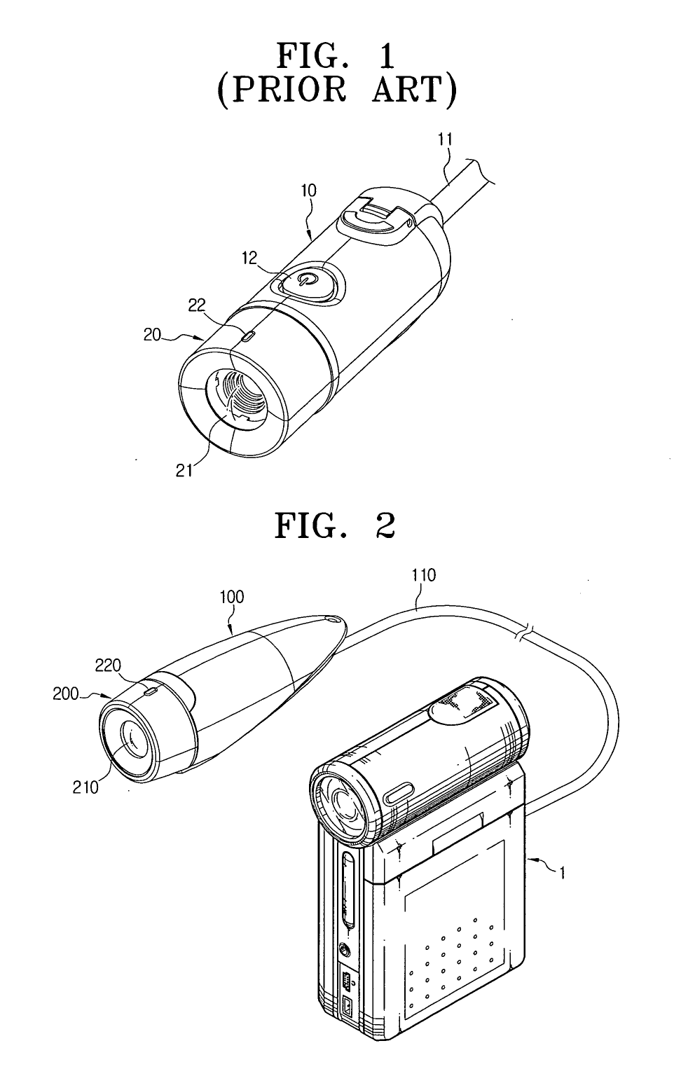

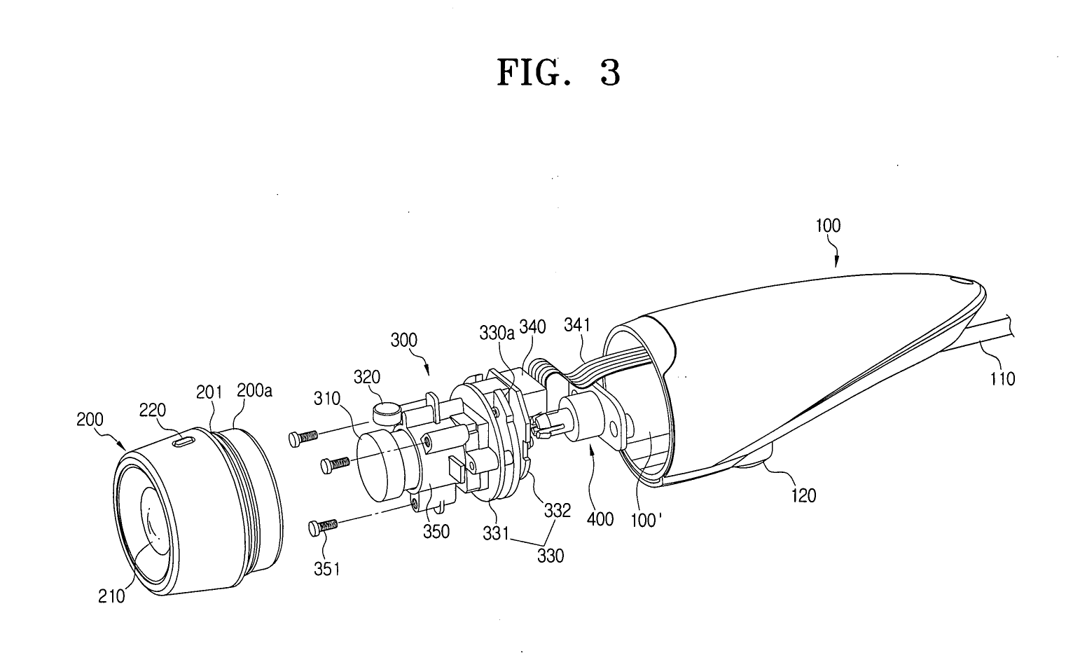

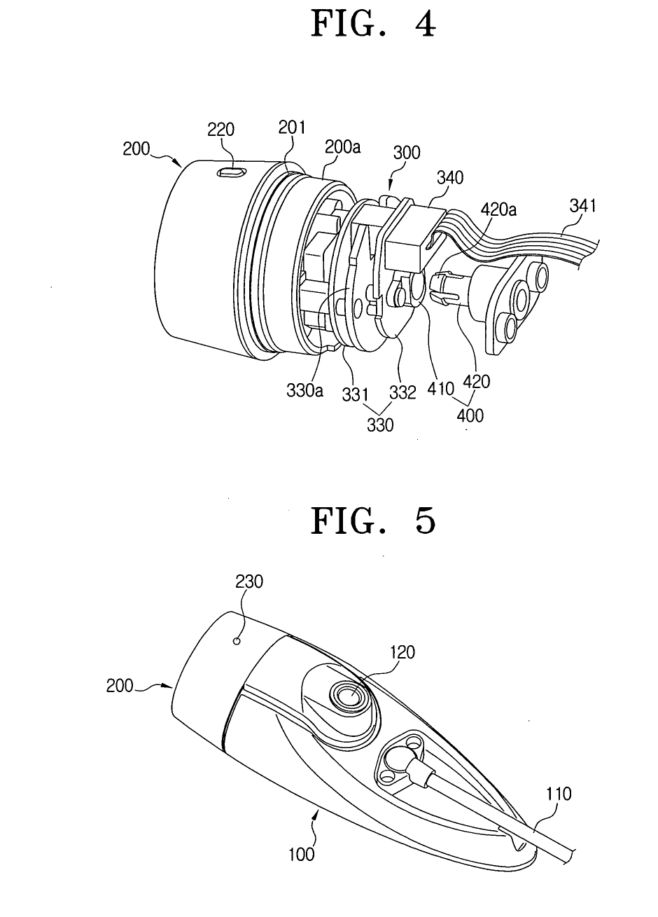

FIG. 2 is a perspective view of an external camera according to an exemplary embodiment of the present invention, FIG. 3 is an exploded perspective view of the external camera of FIG. 2, FIG. 4 is a perspective view of a rotation supporting structure of a camera module of FIG. 3, and FIG. 5 is a bottom perspective view of the external camera of FIG. 2.

Referring to FIGS. 2 to 5, an external camera according to an exemplary embodiment of the present invention includes a case 100, a cover 200, a camera module 300, and a rotation shaft portion 400.

The case 100 is preferably formed in a substantially conical shape. The case 100 may have a substantially cylindrical shape. The case 100 has an open front side, and a receiving space 100′ for the camera module 300. The camera module 300 has a connecting cable 110 for connecting the camera module 300 to a main body 1 of an image photographing apparatus. The case 100 has a socket part 120 to which a supporter socket (not shown) is coupled. Although not shown, a power operating part (not shown) to operate the camera module 300 is preferably provided at either the case 100 or the connecting cable 110.

The cover 200 is formed in a substantially cylindrical shape. An inserting part 200a of the cover 200 is inserted into the front side of the case 100 so that the cover 200 is rotatable with respect to the case 100. A sealing member 201 such as rubber, silicone, or the like is disposed at a connecting part between the case 100 and the cover 200. The sealing member 201 is preferably disposed near an inner end of the outer circumferential surface of the inserting part 200a of the cover 200, as shown in FIGS. 3 and 4. A lens window 210 is detachably disposed at a front side of the cover 200. The cover 200 further includes a LED 220 that blinks on and off according to the operation of the camera module 300, and a microphone hole 230 for picking up sound.

The camera module 300 is fixed to the cover 200 so as to rotate according to the rotation of the cover 200, which is disposed in the receiving space 100′ of the case 100. The camera module 300 includes a lens 310, an image sensor (not shown), a microphone 320, a printed circuit board 330, a connector 340, and a fixing member 350.

The lens 310, the image sensor for sensing images passing through the lens 310, and the microphone 320 for picking up sound are disposed at the printed circuit board 330. The printed circuit board 330 may comprise a plurality of printed circuit boards 331 and 332. Supporting plates 330a are preferably disposed between the plurality of printed circuit boards 331 and 332. The connector 340 is disposed on the printed circuit board 330 and is connected with a connector cable 341. The connector cable 341 is connected to the main body 1 via the connecting cable 110 provided at the case 100. The fixing member 350 supports the lens 310 and is fastened to the cover 200 by fasteners such as screws 351 so as to fix the camera module 300 to the cover 200.

The rotation shaft portion 400 supports the camera module 300 so that it rotates with respect to the case 100. The rotation shaft portion 400 includes a shaft hole 410 disposed at the printed circuit board 330 of the camera module 300, and a rotation shaft 420, which is fixed to the case 100 and inserted into the shaft hole 410. A shaft separation preventing jaw 420a is provided at a leading end of the rotation shaft 420 to prevent the rotation shaft 420 inserted into the shaft hole 410 from separating in an axial direction of the rotation shaft 420.

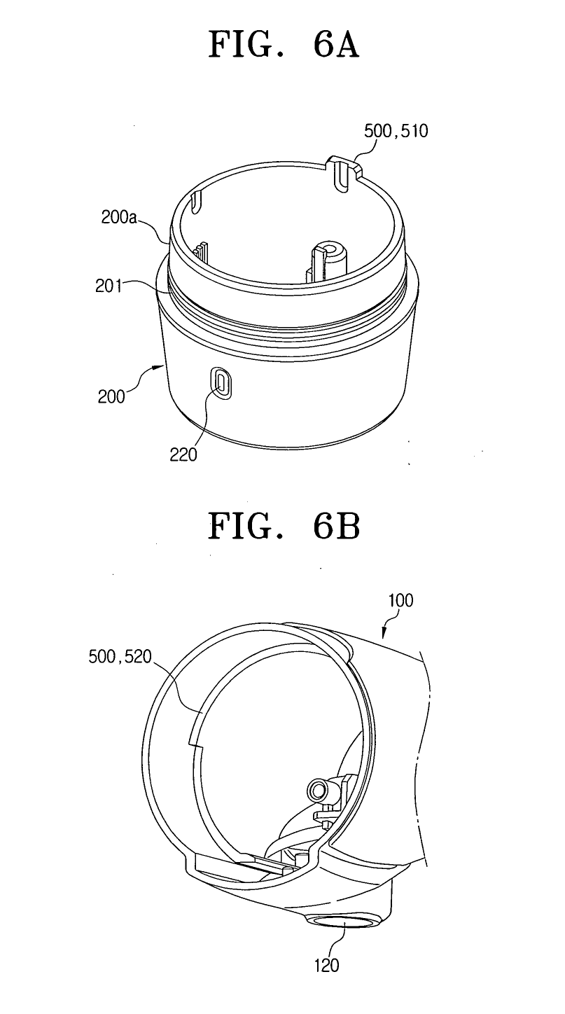

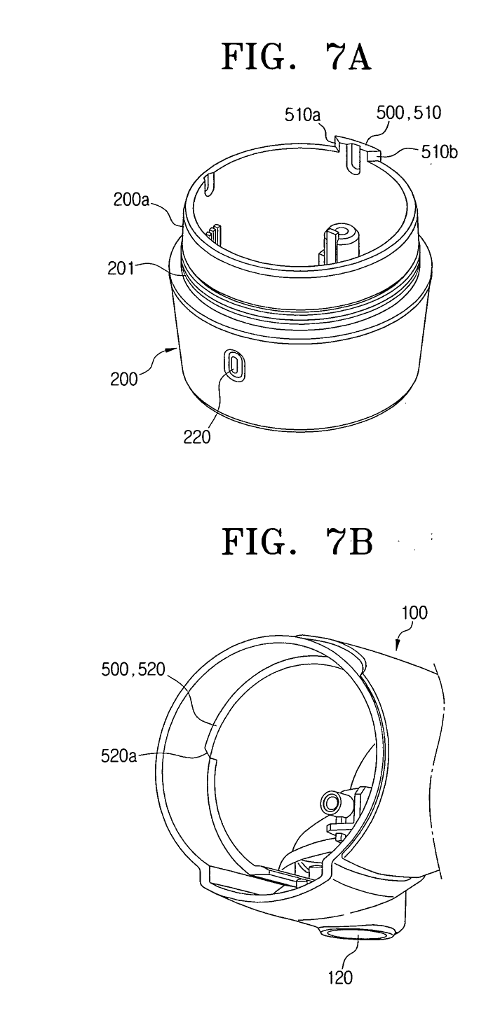

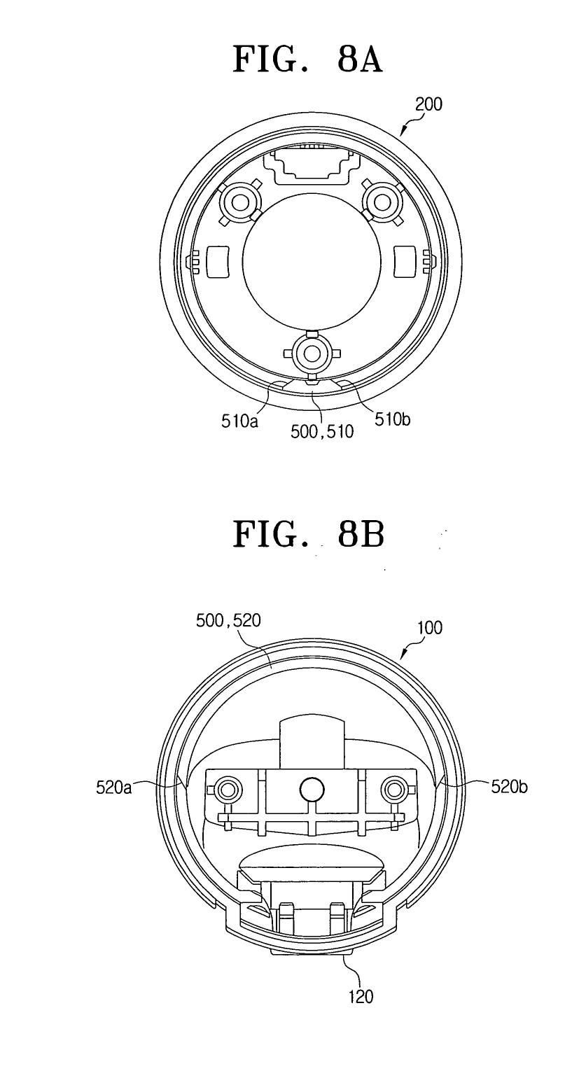

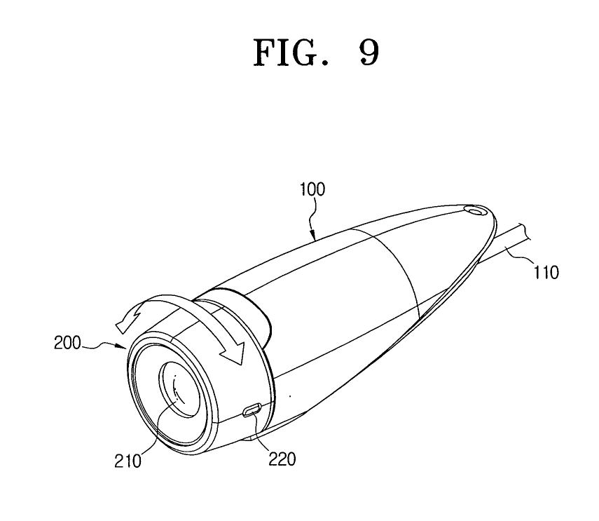

FIGS. 6A and 6B are perspective views of an exemplary embodiment of a rotation limiting structure which is disposed at the cover and the case, FIGS. 7A and 7B are perspective views of another exemplary embodiment of a rotation limiting structure disposed at the cover and the case, and FIGS. 8A and 8B are plan views of the cover and the case of FIGS. 7A and 7B.

Referring to FIGS. 6 to 8B, the external camera according to the exemplary embodiment of the present invention includes a rotation limiting unit 500 controlling the rotation angle of the cover 200 with respect to the case 100.

The rotation limiting unit 500 includes a limiting protrusion 510 formed at the cover 200 and a limiting wall 520 formed at the case 100. The limiting protrusion 510 projects from the inserting part 200a of the cover 200 in an axial direction. The limiting protrusion 510 may have inwardly inclined surfaces 510a and 510b at both sides in the rotation direction (as shown in FIGS. 7A and 8A). The limiting wall 520 is formed at the inner circumferential surface of the case 100 and has substantially the same radius as the rotation radius of the limiting protrusion 510. The limiting wall 520 may have outwardly inclined surfaces 520a and 520b corresponding to the inwardly inclined surfaces 510a and 510b of the limiting protrusion 510 at both ends of the limiting wall 520 (as shown in FIGS. 7B and 8B). The rotation limiting unit 500 limits the rotation of the cover 200 because the limiting protrusion 510 is caught at any one of the both end of the limiting wall 520 when the cover 200 rotates over a predetermined angle with respect to the case 100. Preferably, the cover 200 rotates with respect to the case 100 by approximate 90° to the right and by approximate 90° to the left.

In the external camera according to an exemplary embodiment of the present invention with the above-described structure, the cover 200 is rotatably connected to the case 100, and the camera module 300 fixed to the cover 200 is rotatably supported in the receiving space 100′ of the case 100 by the rotation shaft portion 400. Therefore, the camera module 300 can be rotated from side to side corresponding to the rotation of the cover 200. In other words, the external camera according to the exemplary embodiment of present invention has a camera module 300 which rotates according to the rotation of the cover 200. Consequently, when the external camera has an incorrect horizontal photographing angle, a user may rotate the cover 200 to adjust the horizontal photographing angle of the external camera. Since the photographing angle can be easily adjusted, the degree of freedom for mounting the external camera is higher than that of the conventional external camera. As a result, the external camera is more convenient to use.

Furthermore, in the external camera according to the exemplary embodiment of the present invention, the camera module 300, which is connected to the main body 1 via the connector cable 341 and the connecting cable 110, is fixed to the cover 200, and the cover 200 is able to rotate from side to side with respect to the case 100. When the left and right rotation angle of the cover 200 is not limited, the cover 200 can be over rotated so that the connector cable 341 may be cut or otherwise damaged. However, the external camera according to the exemplary embodiment of the present invention may have the rotation limiting unit 500 that includes the limiting protrusion 510 disposed at the cover 200 and the limiting wall 520 disposed at the case 100. Therefore, when the cover 200 rotates over a predetermined angular range, for example, approximate 90° to the right and approximate 90° to the left, the limiting protrusion 510 contacts the limiting wall 520 so as to block the cover 200 from over rotating. As a result, the rotation limiting unit 500 prevents the connector cable 341 from being damaged by excessive rotation of the cover 200. Also, the limiting protrusion 510 may have inwardly inclined surfaces 510a and 510b at both sides in the rotation direction thereof, and the limiting wall 520 may have outwardly inclined surfaces 520a and 520b corresponding to the inwardly inclined surfaces 510a and 510b at both ends of the limiting wall 520 so that the contact portions of each of the limiting protrusion 510 and the limiting wall 520 has a substantially wedge shaped structure. The wedge structure has a strong force for preventing the cover 200 from rotating so that it is reliable and prevents the connector cable 341 from being damaged.

On the other hand, an image photographing apparatus according to an exemplary embodiment of the present invention includes a main body 1 of a camcorder, and the external camera is connected to the main body 1 via the connecting cable 110 as shown FIG. 2. A detailed description of the main body is omitted because the main body 1 is well-known to those skilled in the art.

In the image photographing apparatus according to an exemplary embodiment of the present invention having the above-described structure, the small external camera is connected to the camcorder via the connecting cable 110 so that users can easily take pictures during leisure, sporting, and other activities.

With the external camera according to an exemplary embodiment of the present invention, the camera module can be rotated by rotating the cover so that users can easily adjust the photographing angle of the external camera. Also, the degree of freedom for mounting the external camera is higher than that of a conventional external camera so that users can conveniently use the external camera.

Furthermore, with the external camera according to an exemplary embodiment of the present invention, the cover only rotates over a predetermined angular range with respect to the case to prevent damage to the cable due to excessive rotation of the cover.

Also, with the external camera according to an exemplary embodiment of the present invention, a separate mount is not required to mount the external camera. Thus, the appearance of the external camera is not limited by mounting requirements.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An external camera comprising:
a case having a receiving space;
a cover rotatably connected to the case; and
a camera module that rotates when the cover rotates, the camera module being disposed in the receiving space.

2. The external camera of claim 1, wherein the camera module is fixed to the cover.

3. The external camera of claim 2, wherein the camera module comprises:
a lens;
an image sensor for sensing images that pass through the lens;
a printed circuit board supporting the image sensor; and
a connector disposed on the printed circuit board for connecting a cable.

4. The external camera of claim 3, wherein the camera module further comprises a microphone.

5. The external camera of claim 4, wherein the camera module further comprises a fixing member for supporting the lens.

6. The external camera of claim 5, wherein the fixing member is fastened to the cover.

7. The external camera of claim 4, wherein the cover further comprises a microphone hole.

8. The external camera of claim 1, further comprising:
a rotation shaft portion that rotatably supports the camera module.

9. The external camera of claim 8, wherein the rotation shaft portion comprises:
a shaft hole formed at the camera module; and
a rotation shaft inserted into the shaft hole, the rotation shaft being fixed to the case.

10. The external camera of claim 9, wherein the rotation shaft comprises a shaft separation preventing jaw for preventing the rotation shaft from separating from the shaft hole.

11. The external camera of claim 1, further comprising:
a rotation limiting unit for controlling a rotation angle of the cover with respect to the case.

12. The external camera of claim 11, wherein the rotation limiting unit comprises:
a limiting protrusion on the cover; and
a limiting wall on the case,
wherein, when the cover rotates over a predetermined angular range, the limiting protrusion is caught at the limiting wall so as to prevent the cover from over rotating.

13. The external camera of claim 12, wherein the limiting protrusion projects in an axial direction.

14. The external camera of claim 13, wherein the limiting wall is formed at an inner circumferential surface of the case and has substantially the same radius as the rotation radius of the limiting protrusion.

15. The external camera of claim 14, wherein the limiting protrusion has inwardly inclined surfaces at both sides in the rotation direction, and
wherein the limiting wall has outwardly inclined surfaces corresponding to the inwardly inclined surfaces at both ends of the limiting wall.

16. The external camera of claim 1, wherein the case comprises a socket part coupled to a supporting socket.

17. The external camera of claim 1, wherein the case further comprises a cable for connecting the camera module to a main body of an image photographing apparatus.

18. The external camera of claim 17, wherein the cable comprises a power operating part for operating the camera module.

19. The external camera of claim 17, wherein the case further comprises a power operating part for operating the camera module.

20. The external camera of claim 1, wherein the cover further comprises a LED that blinks on and off according to the operation of the camera module.

21. The external camera of claim 1, further comprising:
a sealing member disposed between the cover and the case.

22. An image photographing apparatus comprising:
a main body; and
an external camera connected to the main body via a cable, the external camera comprising:
a case having a receiving space;
a cover rotatably connected to the case; and
a camera module that rotates when the cover rotates, the camera module being disposed in the receiving space.

23. The image photographing apparatus of claim 22, wherein the camera module is fixed to the cover.

24. The image photographing apparatus of claim 23, wherein the camera module comprises:
a lens;
an image sensor for sensing images that pass through the lens;
a printed circuit board supporting the image sensor; and
a connector disposed on the printed circuit board for connecting a cable.

25. The image photographing apparatus of claim 23, wherein the camera module further comprises a microphone.

26. The image photographing apparatus of claim 25, wherein the camera module further comprises a fixing member for supporting the lens.

27. The image photographing apparatus of claim 26, wherein the fixing member is fastened to the cover.

28. The image photographing apparatus of claim 25, wherein the cover further comprises a microphone hole.

29. The image photographing apparatus of claim 22, further comprising:
a rotation shaft portion supporting the camera module to rotate with respect to the case.

30. The image photographing apparatus of claim 29, wherein the rotation shaft portion comprises:
a shaft hole formed at the camera module; and
a rotation shaft inserted into the shaft hole, the rotation shaft being fixed to the case.

31. The image photographing apparatus of claim 30, wherein the rotation shaft comprises a shaft separation preventing jaw for preventing the rotation shaft from separating from the shaft hole.

32. The image photographing apparatus of claim 22, further comprising:
a rotation limiting unit controlling a rotation angle of the cover with respect to the case.

33. The image photographing apparatus of claim 32, wherein the rotation limiting unit comprises:
a limiting protrusion on the cover; and
a limiting wall on the case,
wherein, when the cover rotates over a predetermined angular range, the limiting protrusion is caught at the limiting wall so as to prevent the cover from over rotating.

34. The image photographing apparatus of claim 33, wherein the limiting protrusion projects in an axial direction.

35. The image photographing apparatus of claim 34, wherein the limiting wall is formed at an inner circumferential surface of the case and has substantially the same radius as the rotation radius of the limiting protrusion.

36. The image photographing apparatus of claim 35, wherein the limiting protrusion has inwardly inclined surfaces at both sides in the rotation direction, and
wherein the limiting wall has outwardly inclined surfaces corresponding to the inwardly inclined surfaces at both ends of the limiting wall.

37. The image photographing apparatus of claim 22, wherein the case comprises a socket part coupled to a supporting socket.

38. The image photographing apparatus of claim 22, wherein the case further comprises a cable for connecting the camera module to the main body.

39. The image photographing apparatus of claim 38, wherein the cable comprises a power operating part for operating the camera module.

40. The image photographing apparatus of claim 38, wherein the case further comprises a power operating part for operating the camera module.

41. The image photographing apparatus of claim 22, wherein the cover further comprises a LED that blinks on and off according to the operation of the camera module.

42. The image photographing apparatus of claim 21, further comprising:
a sealing member disposed between the cover and the case.

43. An external camera comprising:
a case having a receiving space and an open front side;
a cover inserted into the front side of the case so that the cover is rotatable with respect to the case; and
a camera module rotatably disposed in the receiving space,
wherein the camera module is attached to the cover so that it rotates when the cover is rotated.

44. The external camera of claim 43, wherein the cover includes a lens window.

45. The external camera of claim 43, further comprising a sealing member disposed at a connecting part between the case and the cover.

46. The external camera of claim 43, wherein the camera module comprises:
a lens;
an image sensor for sensing images that pass through the lens;
a printed circuit board supporting the image sensor; and
a connector disposed on the printed circuit board for connecting a cable.

47. The external camera of claim 46, wherein the camera module further comprises a microphone.

48. The external camera of claim 43, further comprising:
a rotation shaft portion that rotatably supports the camera module.

49. The external camera of claim 8, wherein the rotation shaft portion comprises:
a shaft hole on the camera module; and
a rotation shaft inserted into the shaft hole, the rotation shaft being fixed to the case.

50. The external camera of claim 49, wherein the rotation shaft has a shaft separation preventing jaw for preventing the rotation shaft from separating from the shaft hole.

51. The external camera of claim 43, further comprising:
means for controlling the rotation angle of the cover with respect to the case.

52. The external camera of claim 51, wherein the controlling means comprises:
a limiting protrusion on the cover; and
a limiting wall on the case,
wherein the limiting protrusion intersects the limiting wall to prevent the cover from over rotating.

53. The external camera of claim 52, wherein the limiting protrusion projects in an axial direction.

54. The external camera of claim 53, wherein the limiting wall is formed at an inner circumferential surface of the case and has substantially the same radius as the rotation radius of the limiting protrusion.

55. The external camera of claim 54, wherein the limiting protrusion has inwardly inclined surfaces at both sides in the rotation direction, and
wherein the limiting wall has outwardly inclined surfaces corresponding to the inwardly inclined surfaces at both ends of the limiting wall.
